(19) United States
(12) Patent Application Publication
(10) Pub. No.: US 2025/0058892 A1
(43) Pub. Date: Feb. 20, 2025

(54) METHOD FOR PROCESSING DATA OF AN AIRCRAFT PILOTING ASSISTANCE DEVICE

(71) Applicant: THALES, MEUDON (FR)

(72) Inventors: Amalia LOPEZ SANDOVAL, TOULOUSE (FR); Fany BARAILLER, TOULOUSE (FR); Sylvain YAN, TOULOUSE (FR)

(21) Appl. No.: 18/721,467

(22) PCT Filed: Nov. 9, 2022
(86) PCT No.: PCT/EP2022/081346

§ 371 Date: Jun. 18, 2024

(30) Foreign Application Priority Data
Dec. 21, 2021 (FR) 2114065

(51) Int. Cl. B64D 43/00; G06T 11/60

(52) U.S. Cl. CPC B64D 43/00; G06T 11/60; G06T 2200/24

(57) ABSTRACT

A method for processing data generated by an event management device determining mission adaptation suggestions from current or future mission data sources, the method comprising the following steps of: receiving at least one suggestion comprising an item of information and a datum related to its construction; generating a notification for each received suggestion; storing the notification in a notifications memory. The method further comprises at least one iteration of the following steps: applying a classification operation to the notification; applying processing to the notification as a function of the classification operation, the processing comprising a step of rendering the notification on a Human-Machine interface in response to a display condition, the rendering using a display form and display dynamics.

### CROSS-REFERENCE TO RELATED APPLICATIONS

This application is a National Stage of International patent application PCT/EP2022/081346, filed on Nov. 9, 2022, which claims priority to foreign French patent application No. FR 2114065, filed on Dec. 21, 2021, the disclosures of which are incorporated by reference in their entireties.

### FIELD OF THE INVENTION

The invention generally relates to the field of managing aircraft missions, and in particular to a method for processing data of an aircraft piloting assistance device.

### BACKGROUND

Aircraft, whether they are civilian or military, are increasingly complex. Strategic management of the current and future missions of an aircraft involves an increasingly high workload for the crew, and notably for the pilots, when an event occurs. An event can be an event inside the aircraft, such as a failure of a system, a medical problem of a passenger, or an event outside the aircraft, such as, for example, a change in weather or damage to a facility. An event also can be an operational event, such as, for example, a modification to the initially planned mission, possibly resulting from an internal or external event.

Known solutions for assisting and/or managing current and future missions of an aircraft are conventionally either purely avionics systems or open-world systems. By definition, purely avionics systems, called ‘certified systems’ (or sometimes ‘certified avionics systems’), are subject to certification constraints on the hardware and the software. The open-world systems, called ‘non-certified systems’ (or sometimes ‘non-certified avionics systems’), are not subject to the same certification constraints as the certified systems. The non-certified systems cover hardware that can host software that is not certified but is subject to operational approval of the aircraft. The non-certified systems have the advantage of having fewer development constraints, with shorter development and deployment processes.

These non-certified systems do not take into account all the data originating from the certified and non-certified systems of the aircraft. For example, the non-certified systems are not connected to the avionics. They therefore have an incomplete picture of a current situation because they do not continuously integrate the status of the aircraft and the evolution of the planned mission. Therefore, these systems are not able to provide the operators of the aircraft with proposals or suggestions allowing them to make a relevant decision as a whole. On the contrary, each of the known solutions only presents pockets of information that on their own do not allow an overall picture to be generated of the flight context and of the environmental context.

The non-certified systems are generally made up of several applications, each having a specific functionality, which are not suitable for delivering suggestions relating to the mission as a whole. Typically, the non-certified systems merely present the operators of the aircraft with summarized displays of situations. Finally, the non-certified systems do not propose displaying information based on the principle of providing the operators of the aircraft with notifications of information.

The certified systems above all address the tactical and safety aspects of a change in context, i.e. oriented toward an immediate reaction from the crew operators. The certified systems are not able to analyze the consequences of a current situation over the medium and/or long term. Even if these certified systems evolved in order to integrate suggestion capabilities, they would be quickly limited in terms of computation power and also in terms of the ability to collect new data, notably because their development and evolution cycles are long cycles, and obviously because of the certification constraints.

With the various systems of the prior art, when a change in the status of the aircraft or an external event occurs, the crew operators of an aircraft must analyze the information provided by numerous systems and must determine the strategy for adapting the mission that appears to be the best to them.

Most of the time, the crew operators of an aircraft have to be satisfied with analyzing a subset of data that to them appears to be relevant, because they have neither the time nor the ability to reconsider the context as a whole, since there is too much information. Furthermore, the crew operators of an aircraft assume that only the only changes with respect to the initial situation are those that triggered the analysis. However, such an assumption is not always the case. For example, the weather at one of the possible diversion airports may have evolved between the preparation of the flight and its completion. The crew operators of an aircraft can decide to divert to this inoperative airport, which corresponds to a poor diversion solution.

Some existing solutions of an aircraft piloting assistance device aim to provide the crew operators with assistance in order to allow them to analyze the impact of a change in context on a current mission, as described in documents U.S. Pat. No. 10,096,253 and U.S. Pat. No. 10,109,203, for example.

However, these known solutions are based on presenting the crew with raw information directly originating from a few systems. These known solutions do not provide proposals for suggestions established based on multiple criteria, according to all the various available systems.

The existing solutions for an aircraft piloting assistance device do not provide a dynamic method for computing suggestions and for generating information notifications derived from such suggestions, allowing the crew operators to analyze the impact of a change in context on the current mission of the aircraft by taking into account the data from all the various certified and non-certified systems.

Thus, a requirement exists for an improved method for processing data originating from an aircraft piloting assistance device.

### SUMMARY OF THE INVENTION

The present invention improves the situation by proposing a method for processing data generated by an event management device, with the device determining mission adaptation suggestions from current or future mission data sources, the method comprising the following steps of:
receiving, from the event management device, at least one suggestion, the suggestion comprising at least one item of information and at least one datum related to the construction of the suggestion;
generating at least one notification for each received suggestion as a function of at least one of the items of information, the notification comprising the suggestion and at least one metadata structured from a metadata register;
storing the at least one notification in a notifications memory.

The method further comprises at least one iteration of the following steps:
applying a classification operation to a notification stored in the notifications memory, the classification operation associating a class X with the notification, the class being determined as a function of predefined rules from a set of classes comprising at least a first class V and a second class W;
applying processing to the notification as a function of the determined class X, the processing comprising a step of rendering the notification on a Human-Machine interface if the class X meets a display condition depending on whether the class X belongs to the first class V or to the second class W, the rendering using at least one display form and display dynamics defined as a function of the metadata associated with the notification.

In a particular embodiment, the predefined rules for determining the class X can depend on a set comprising weighting criteria, criteria defined by an ontology and/or criteria defined by rules.

The current or future mission data sources can comprise the data acquired from various systems of the certified avionics or of the non-certified avionics and/or from various outside sources or sources inside the aircraft, the method further comprising a step of transferring data to the systems of the certified avionics and/or of the non-certified avionics.

In one embodiment, the data transfer step can comprise a step of rendering the notification on at least one other Human-Machine interface connected to the certified avionics and/or non-certified avionics systems.

Advantageously, the notification can comprise timestamp metadata, the timestamps comprising a generation timestamp for the notification, at least one classification timestamp for the notification, at least one processing timestamp for the notification and/or at least one action timestamp related to the execution of an action.

In a particular embodiment, the first class V can identify a “to be executed” notification indicating that the notification must be executed, and the second class W identifies a “to be archived” notification indicating that the notification must be archived in a backup memory connected to the current or future mission data sources.

The classes can further comprise a third class U identifying a “standby” notification indicating that the notification must be placed on standby.

In a particular embodiment, the class X meets the reclassification condition of X⊆U∨X⊆V, with the processing step comprising reiterating the step of applying a classification operation.

The step of reiterating the classification operation can be triggered as a function of:
controlling a duration determined from the timestamp metadata;
modifying the data acquired during a mission; and/or
controlling an action detected on the Human-Machine interface.

In a particular embodiment, the class X meets the backup condition of X⊆W, with the processing step comprising a step of deleting the notification from the notifications memory and a step of archiving the notification in the backup memory.

In some embodiments, the metadata register can further comprise:
a simple metadata associated with the notifications comprising an item of information or an action relating to at least one mission parameter, the information or action being determined from the suggestion; and
a complex metadata associated with the notifications comprising a concatenation of several items of information or actions relating to at least one mission parameter, the information or actions being determined from the suggestion.

The metadata register can further comprise a priority metadata associated with the notifications, the priority metadata being determined from the suggestion and updated at each step of the method, with the priority metadata being associated with the importance and/or the urgency of the information or actions relating to at least one mission parameter, the priority metadata comprising at least two priority indicators, including a high priority indicator and a moderate priority indicator.

In particular, the metadata register can comprise metadata defining the category of the information and/or actions relating to the suggestion from among environmental categories, and the status of the aircraft.

In embodiments, the display form defined as a function of the metadata associated with a notification can comprise a first display form and a second display form, with the rendering step using the first display form to generate the display of at least:
a first graphical element, with the selection of the graphical element triggering the second display form;
a second graphical element containing an item of information or an action relating to at least one mission parameter, with the information or action being determined from the suggestion, with the selection of the graphical element triggering the display of the information or action in a first zone of the second display form.

The rendering step can comprise:
counting notifications from the number of non-rendered notifications using the second display form;
incrementing the number of non-rendered notifications using the second display form.

The rendering step can use the first form to also generate the display of the number of counted notifications not displayed in the second display mode.

Alternatively, the rendering step can use the second display form to generate the display of at least:
the first zone comprising a first set of at least one graphical element, generated from a suggestion of a notification whose class X meets the condition of X⊆V, the graphical elements of the first set comprising displaying at least one item of information or an action relating to at least one mission parameter, the item of information or action being determined from the suggestion, the graphical elements further comprising displaying at least one duration defined by the timestamp metadata of the suggestion;
a second zone comprising a second set of at least one graphical element, the selection of the graphical elements of the second set triggering filtering of the rendering of the notifications according to filtering criteria;
a third zone comprising a third set of at least one graphical element, generated from a suggestion of a notification whose class X meets the condition of X⊆W, the third set comprising a triggering graphical element, with the selection of the triggering graphical element triggering the display or the occlusion of the third zone;
a fourth zone comprising a fourth set of at least one graphical element, with the selection of the graphical element triggering the interruption of the rendering step.

Advantageously, if, after an iteration of the step of applying a classification operation for a notification of class X⊆U, the class X of the notification meets the condition of X⊆V, with the notification being associated with a type of metadata, then the rendering step uses the first display form for a duration defined by the timestamp metadata of the notification.

In embodiments, if, after an iteration of the step of applying a classification operation for a notification of class X⊆U, the class X of the notification meets the condition of X⊆V, with the notification being associated with a complex metadata, then the rendering step uses the second display form.

A computer program product is also proposed comprising instructions for executing the method when the program is executed by a processor.

The invention also provides a device for processing mission adaptation suggestions generated from current or future mission data sources, the suggestions being generated by an event management device, the device being configured for:
receiving, from the event management device, at least one suggestion, the suggestion comprising at least one item of information and at least one datum related to the construction of the suggestion;
generating at least one notification for each received suggestion as a function of at least one of the items of information, the notification comprising the suggestion and at least one metadata structured from a metadata register;
storing the at least one notification in a notifications memory.

The device is further configured to implement at least one iteration of the following operations:
applying a classification operation to a notification stored in the notifications memory (166-4), the classification operation associating a class X with the notification, the class being determined as a function of predefined rules from a set of classes comprising at least a first class V and a second class W;
applying processing (450) to the notification as a function of the determined class X, the processing comprising a step (452) of rendering the notification on a Human-Machine interface (180) if the class X meets a display condition depending on whether the class X belongs to the first class V or to the second class W, the rendering using at least one display form and display dynamics defined as a function of the metadata associated with the notification.

The embodiments of the invention thus provide an improved aircraft piloting assistance device capable of computing suggestions, of generating a display of such suggestions and of dynamically interacting with the crew operators through such a display. Such interactions are adapted to minimize the mental load of the crew operators, and to provide an optimized response time for the assistance device.

The aircraft piloting assistance device and method according to the embodiments of the invention allow all the available information to be correlated and allow a crew, even a reduced crew, to be sent the best options (suggestions) so as to allow quick and reliable decision-making, throughout all the steps of a flight. The information delivered by the aircraft piloting assistance device and method according to the embodiments of the invention thus allow optimal management of the tasks of the crew, even when they are numerous.

### BRIEF DESCRIPTION OF THE DRAWINGS

Further features, details and advantages of the invention will become apparent from reading the description, which is provided with reference to the appended drawings, which are provided by way of an example and in which:

FIG. 1 is a diagram of a computer architecture implementing the method of the invention;

FIG. 2 is a diagram of an event management device, according to embodiments of the invention;

FIG. 3 is a diagram of a device for processing suggestions implementing the data processing method, according to embodiments of the invention;

FIG. 4 is a flowchart showing the steps of the data processing method, according to embodiments of the invention;

FIG. 5 is a flowchart showing the step of processing notifications of the data processing method, according to embodiments of the invention;

FIG. 6 shows several examples of rendering of notifications, in condensed form, on a Human-Machine interface;

FIG. 7 shows an example of rendering of several notifications, in extended form, on a Human-Machine interface;

FIG. 8 shows an example of rendering a complex notification, in extended form, on a Human-Machine interface.

An identical reference used in several figures designates identical or similar elements.

### DETAILED DESCRIPTION

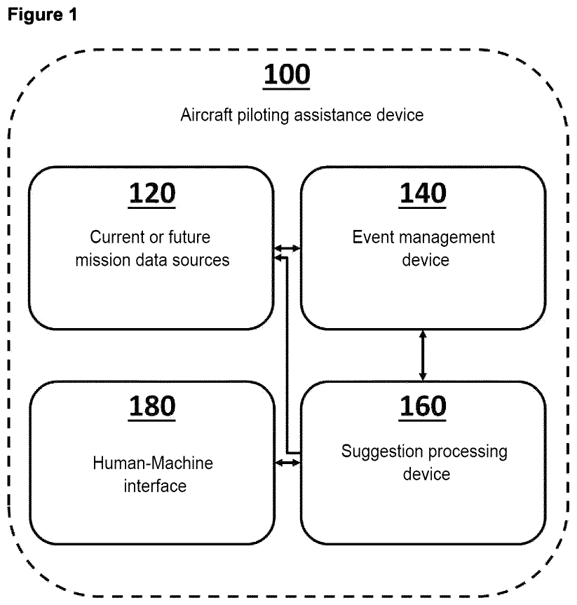

FIG. 1 is a diagram of a computer architecture of the aircraft piloting assistance device 100 according to embodiments of the invention.

The aircraft piloting assistance device 100 comprises current or future mission data sources 120, an event management device 140, a suggestion processing device 160 and a Human-Machine interface 180.

As used herein, the current or future mission data sources 120 refer to all the data that can be acquired by the aircraft piloting assistance device 100 through various systems of the certified avionics or non-certified avionics and/or various outside sources (such as the environment and the weather) or sources inside the aircraft. These data can be accessed by the event management device 140.

The event management device 140 is configured to carry out an analysis and then reliably correlate all the content of the relevant current or future mission data sources 120 relating to an aircraft. The event management device 140 is notably configured to determine whether an adaptation of a current situation must be carried out by the aircraft crew. If necessary, the event management device 140 can provide the crew of the aircraft with one or more suggestions representing the solutions that appear to be most relevant for this adaptation.

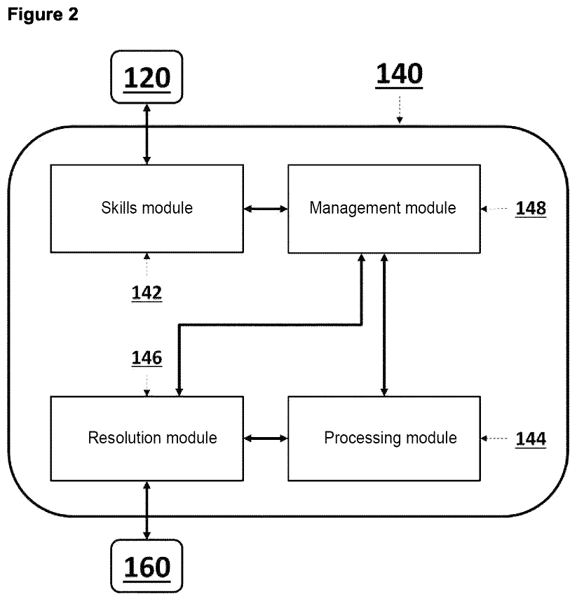

As illustrated in FIG. 2, the event management device 140 can include a skill module 142. This module comprises one or more computation units not shown in the figure. These computation units can be configured to compute events from the current or future mission data or parameters, in order to process resolution requests and/or to generate resolution proposals.

The event management device 140 can further comprise a processing module 144 configured to determine the existence of an impact on the current mission (or on a parameter associated with a mission, called mission parameter) of the aircraft, either based on a computed event, or based on a resolution proposal.

The event management device 140 can also comprise a resolution module 146 configured to transmit the resolution requests based on the existence of an impact, to evaluate and select resolution proposals according to predefined criteria, and to thus construct a suggestion, characterized as a solution for adapting the current mission of the aircraft based on at least one resolution proposal.

In one embodiment, the event management device 140 can comprise a management module 148 configured, on the one hand, to manage restraints and priorities of streams, and, on the other hand, to switch the exchanges between the various modules of the device.

As used herein, a ‘suggestion’ designates one or more items of information and/or a proposal for actions, relating to one or more mission parameters, predefined by the event management device 140. A suggestion is intended to be displayed on the Human-Machine interface 180. The information relating to a ‘suggestion’ can further comprise auxiliary data associated with some or all of the elements associated with the construction of the suggestion (construction elements). The auxiliary data can be, for example, context data associated with the construction of the suggestion (for example, a suggestion to divert to a nearby airport following a context involving the failure of the avionics system). The actions associated with a suggestion can be executed by at least one member of the crew. The suggestions computed by the event management device 140 can be used by the crew operators as a decision-making assistance medium, for example within the context of flight planning and mission tasks, management of the current mission and of cockpit systems, up to the arrival of the aircraft at its final destination. Thus, a suggestion can include a set of messages and/or specific digital data able to be used by the crew for assisting decision-making. The suggestions determined by the event management device 140 can be of different types, such as, for example, suggestions corresponding to a reminder of actions or strategic information (for example, optimization suggestion or even an alternative suggestion following an unplanned event).

The mission management device 140 of the aircraft can be connected to the suggestion processing device 160, for example via the resolution module 146, which can transfer the constructed and selected suggestions. Advantageously, the suggestion processing device 160 according to the embodiments of the invention allows the crew of the aircraft to be notified of suggestions, by implementing sorting and organized analysis of the suggestions before they are displayed on the Human-Machine interface 180, at different scales. Such a display generated from optimized processing of the suggestions allows the crew to process suggestions with all types of complexity, such as basic suggestions (such as memos) and/or complex suggestions (such as strategic proposals). Such processing of the suggestions is carried out so as to provide relevant information, with computational complexity and an optimized response time, which optimizes the actions of the crew in a multifunctional environment involving significant information.

The Human-Machine interface 180 is at least connected to the suggestion processing device 160. The Human-Machine interface 180 is configured to manage the interactions of one or more operators with various computer components of the aircraft piloting assistance device 100. According to some embodiments, the Human-Machine interface 180 of the aircraft piloting assistance device 100 can be a specific Human-Machine interface from among a set of Human-Machine interfaces that can be associated with one or more other cockpit systems. Advantageously, the Human-Machine interface 180 can be arranged in a space dedicated to the aircraft piloting assistance device 100, which can be used at any time by the various crew operators of the aircraft for assisting “Situational Awareness”, decision-making, or for carrying out other actions.

The interactions between operators and computing devices can be multi-modal. As a result, the exchanges of information can be visual, i.e. textual and graphical, audible or even tactile/haptic.

The implementation of the aircraft piloting assistance device 100 can be carried out, for example, by integrating various components on a computing platform of the certified avionics or of the non-certified avionics, or can be distributed between computing platforms of the certified avionics, computing platforms of the non-certified avionics and computing platforms of a ground infrastructure. The platform of the ground infrastructure is connected to the avionics platform by a data link.

As used herein, an action associated with a suggestion refers to an action that can be executed by the crew by acting on at least one of the cockpit systems.

An action that can be executed by the crew thus can be an action on the Human-Machine interface 180 by one or more crew operators, using input means (pointing device, such as a mouse or keyboard, gestures on a touch screen, voice control, etc.). A display of a suggestion can be generated on the Human-Machine interface 180, on a display device (screen, for example). The input means (mouse or keyboard, for example) can be used by a crew operator in order to select one or various options associated with the suggestions, in response to this display. The crew operator can also choose to reject a suggestion fed back by the event management device 140, for example by clicking on a touch-sensitive button displayed on the Human-Machine interface indicating “Reject”. The crew operator can also choose to request, via the Human-Machine interface 180, additional information regarding the suggestion and/or the available information used to construct the proposed suggestion, by clicking on a touch-sensitive button associated with the term “Show more information”. The crew operator can also choose to apply the suggestion, by clicking on a touch-sensitive button indicating “Accept”. Such a specific action can cause, for example, an automaton within the aircraft piloting assistance device 100 to open one of the non-certified systems, in order to include the information relating to the accepted suggestion within a flight plan in a workspace connected to a non-certified system. Advantageously, this workspace can be connected to a third-party service for importing the flight plans produced in a certified system.

An action of the crew also can be defined as an action directly carried out by one or more crew operators on a certified system, such as a heading modification action, an altitude adjustment action, or even a change of frequency action. Thus, an action of the crew can be defined as an action (or manipulation) carried out on the certified or non-certified system.

Advantageously, the method of the invention and the associated device allow the elements of the adaptation solution to be transferred from the current mission of the aircraft to the current or future mission data sources 120 associated with the certified avionics or non-certified avionics platforms and with a ground infrastructure. Thus, the suggestion processing device 160 also can be connected to the current or future mission data sources 120 in order to back up all the processed suggestions and the information related to the processing thereof. This backup operation thus allows predefined criteria for constructing resolutions to be enhanced and therefore allows the event management device 140 to search for adaptation solutions. This search for a solution thus becomes more efficient over time.

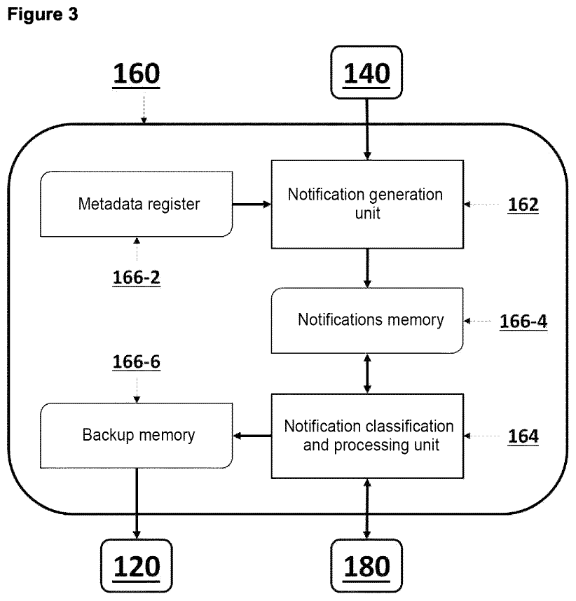

The suggestion processing device 160 is shown in more detail in FIG. 3, according to embodiments. As illustrated in FIG. 2, the suggestion processing device 160 can include a notification generation unit 162 able to receive suggestions from the event management device 140.

The notification generation unit 162 is configured to generate notifications based on these suggestions and on a metadata register 166-2 included in the suggestion processing device 160. The metadata designate technical data models for characterizing a notification. A metadata register refers to a metadata management system. A ‘notification’ thus includes:
the one or more items of information (or actions) related to the suggestion; and
metadata characterizing the notification.

The notification generation unit 162 can further include an internal clock configured to associate a timestamp with the generation of the notification. In embodiments, the timestamp, called ‘creation timestamp’, can be included in one of the metadata of the notification.

The notification generation unit 162 also can be configured to store the created notifications in a notifications memory 166-4 included in the recommendation processing device 160.

In some embodiments, the suggestion processing device 160 can include a notification classification and processing unit 164 adapted to associate a specific mathematical class with the notifications stored in the notifications memory 166-4.

A class, also called status, refers to a set to which a notification can belong.

In embodiments, the notification classification and processing unit 164 can use a set of predefined criteria to associate a specific mathematical class with the notifications. These criteria can include weighting criteria, criteria defined by an ontology and/or criteria defined by rules.

The notification classification and processing unit 164 is thus configured to carry out a classification operation for a notification, defined as an analysis, according to predefined rules, for all the information of the notification and to compute the status of the notification based on this analysis.

The notification classification and processing unit 164 is further configured to process the notification as a function of the class associated therewith. This operation for processing the notification can correspond to the application of a new operation for classifying the notification defined as a reclassification operation and/or to rendering the notifications on the Human-Machine interface 180, and/or to storing the notifications in a backup memory 166-6.

According to some embodiments, a class can correspond to a status, called “standby” status, indicating that the notification is to be placed on standby by the notification classification and processing unit 164. If the class is in a “standby” status, a display will not be generated on the Human-Machine interface 180 for the suggestion.

A class can correspond to a status, called “to be executed” status, indicating that the notification must be executed by the notification classification and processing unit 164. If the class is in a “to be executed” status, a display will be generated on the Human-Machine interface 180 for the suggestion.

A class can correspond to a status, called “to be archived” status, indicating that the notification must be archived in a backup memory 166-6 connected to the notification classification and processing unit 164 within the suggestion processing device 160. If the class is in a “to be archived” status, an archiving rendering will be generated on the Human-Machine interface 180 for the suggestion.

In some embodiments, the notifications memory 166-4 of the suggestion processing device 160 only includes the notifications with a “standby” or “to be executed” status.

The backup memory 166-6 can form, for the aircraft piloting assistance device 100, a data source inside the aircraft within the current or future mission data sources 120.

According to some embodiments, rendering a notification can be generated multiple times and can be controlled by the notification classification and processing unit 164. Rendering a notification uses at least one display form and display dynamics defined as a function of the metadata associated with the notification.

The notification classification and processing unit 164 can also comprise an internal clock used to associate one or more timestamps with the classification or reclassification of the notification, one or more timestamps with the processing of the associated notification (notably with multiple renderings), and/or one or more timestamps associated with the execution of actions of the crew that can be associated with the notification. Thus, according to some embodiments, the classification timestamps, the processing timestamps, and the action timestamps can be added to the notification generation timestamp, notably, for example, in metadata called ‘timestamp metadata’.

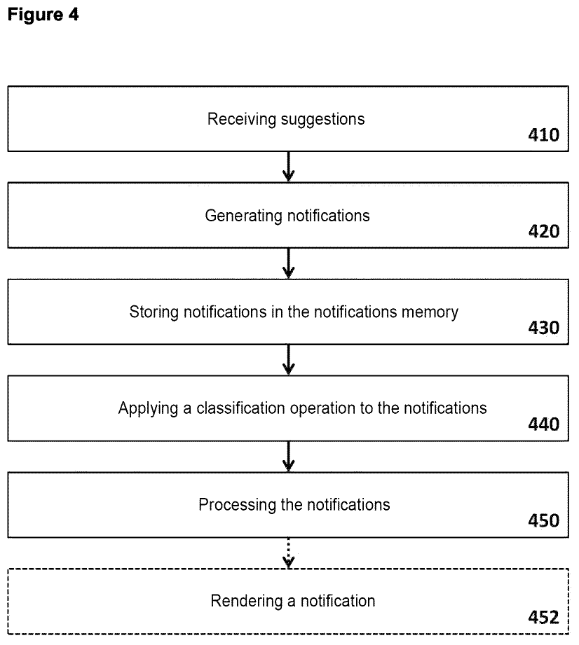

FIG. 4 is a diagram describing the steps of the data processing method according to embodiments of the invention. The data processed by this method are suggestions generated by an event management device 140 from current or future mission data sources 120.

In step 410, a suggestion is received by the suggestion processing device 160.

In step 420, a notification is generated for each received suggestion from at least one item of information (or action) of the suggestion, such that the notification includes the information relating to the suggestion and at least one metadata structured based on a metadata register 166-2.

In step 430, the notification is stored in the notifications memory 166-4.

In step 440, a classification operation is applied to the notification contained in the notifications memory 166-4. During this step, a specific mathematical class is associated with the notifications.

In step 450, the notification is processed as a function of the associated mathematical class. Steps 440 and 450 of applying a notification classification and processing operation are implemented by the notification classification and processing unit 164.

In step 452, a rendering is generated on the Human-Machine interface 180.

According to some embodiments, the data processing method can comprise a step of transferring data (not shown in the figures) to the systems of the certified avionics and/or of the non-certified avionics. Notably, during this data transfer step, a notification can be rendered on another Human-Machine interface connected to the systems of the certified avionics and/or of the non-certified avionics.

In order to carry out the step of rendering on the Human-Machine interface 180, the notification classification and processing unit 164 can use the information included in the metadata of the notification. In particular, one or more metadata can characterize the type of notification. A type of notification refers to the overall behavior of a notification. As used herein, the overall behavior of a notification encompasses all the elements for rendering the notification on the Human-Machine interface 180 according to various display forms and the display dynamics of these rendering elements. To this end, the type specifies the one or more forms by which the notification will be displayed in the Human-Machine interface 180 in order to render the associated suggestion. These forms allow one or more interactions, which can be multi-modal, between one or more operators of the aircraft and the suggestion processing device 160. A type of notification also specifies the dynamics for depicting the one or more various predefined forms, notably as a function of the timestamp metadata of the notification.

The step 420 of generating a notification can thus include determining one or more metadata, called ‘type of metadata’, from the metadata register 166-2, according to predefined rules associated with the notification generation unit 162, and as a function of the information relating to the suggestion.

According to some embodiments, a notification can be characterized by “simple” metadata or by “complex” metadata. Complex metadata can be “complex informative” or “complex recommendation” metadata. In order to better understand the invention, by way of a non-limiting example, the following description of some embodiments will be provided with reference to some examples of mechanisms for associating a type of metadata with a notification, according to an analysis of the suggestion. Advantageously, the analysis of the suggestion can be used to determine whether the proposal of an action or the information included in the suggestion is clear and succinct, or even self-sufficient, and can be easily assimilated by one or more crew operators so that the consequence of an action to be implemented is obvious to the one or more crew operators. This analysis of the suggestion can be implemented by the notification generation unit 162 or even previously by the event management device 140. This analysis by the device 140 results in a ‘type of information’, for example (included in the suggestion transmitted to the suggestion processing device 160) for generating the type of metadata. A person skilled in the art will easily understand that the mechanisms for associating a type of metadata can be generalized to other cases in order to construct the set of predefined rules in order for the notification generation unit 162 to construct the notifications. A rule for generating a notification, called ‘simple notification’, can be defined by listing a single action, or a single item of information, relating to one or more parameters associated with a mission.

A simple notification therefore can correspond to an elementary command intended to be carried out by a crew operator of the aircraft on a single cockpit system. A simple notification can also comprise elementary information to be transmitted to the crew such as, for example, information indicating that the status of the flight plan has been updated, with the updated status being one of the statuses from among: a “draft” status, a “rejected” status or a “validated” status.

Another rule for generating a simple notification can be defined if the one or more actions can be directly preset (or pre-adjustable) in the avionics systems, so that a crew operator for the aircraft can simply implement these actions by checking and validating the proposed action in the avionics systems, without requiring any direct action in the Human-Machine interface 180, if these proposals for action are suitable.

According to the next example, even though it is by no means limiting, a simple notification can therefore correspond to a single flight management action, computed by the event management device 140 after communications are detected between an air traffic controller and the crew. Notably, the air traffic controller may have provided, for example orally, the crew with one or more authorizations such as “Ascend to level FL150”, or even “Take heading 130”. Such an authorization is expressed by the event management device 140 as a suggestion associated with a simple action. Advantageously, a simple notification avoids the need for the crew to take notes when listening to instructions from the air traffic controller. Thus, the aircraft piloting assistance device 100 can be easily programmed to recognize these suggestions and to subsequently automatically preset these actions in a system of the avionics.

Furthermore, a rule for generating a notification, called ‘complex notification’, can be defined by listing several actions and/or several items of information, relating to one or more parameters associated with a mission.

According to the next example, even though it is by no means limiting, a complex notification can therefore correspond to one or more commands with several handling constraints for one or more crew operators of the aircraft, such that they generate, for example, actions to be carried out on several functions of the avionics that are not necessarily co-located, or several cockpit systems. A complex notification can also comprise several items of information originating from various sources of current or future mission data 120, which the crew operator must take into account in order to process the notification. For example, such a notification can be a proposal to divert to a nearby airport following a system failure of the avionics.

In particular, a rule for generating a notification, called ‘complex informative notification’, can be defined as a complex notification allowing the actions to be carried out in the systems of the avionics to be prepared in advance.

A notification of the ‘complex informative’ type can correspond to several items of information or proposals for actions for adjusting the heading, setting the altitude, changing frequency, etc. Advantageously, a ‘complex informative’ notification avoids the need for the aircraft crew operators to take notes during the phase of preparing current or future flight steps. A “complex informative” notification also can be a concatenation of simple notifications allowing automatic presetting of numerous actions in various systems of the avionics. For example, such a notification can be an ATC instruction proposal: “Descend to alt. 10,000 ft at 25 nm before WPT” (technical instruction in the field).

A rule for generating a notification, called ‘complex recommendation notification’, can be defined as a complex notification affecting the current mission, notably affecting the flight plan or comprising several possible choices to be made by one or more crew operators of the aircraft. In this case, the notification is sufficiently comprehensible to explain to the operators the suggestion constructed by the event management device 140. Advantageously, such a notification is issued in order to optimize performance and to propose alternative strategies for a current or future mission.

A “complex recommendation” notification can correspond to a suggestion containing various choices computed and retained by the event management device 140 according to various criteria, for example, the Flight Policy, special requests, called VIP requests, etc. A “complex recommendation” notification can be connected, for example, to the detection of a weather event affecting the current mission, notably with the event management device 140 computing the need to modify the flight plan in order to bypass the weather zone that cannot be accessed by the aircraft.

According to another example, following a system failure of the avionics (for example a hydraulic failure, or in the event of an engine fire on the aircraft), the event management device 140 can take into account several current or future mission data sources 120, such as weather, avionics performance or even airport information data sources, in order to determine one or more suggestions relating to maintaining the current mission, and/or to modifying the current mission and/or future missions. A “complex recommendation” notification can be connected, for example, to the proposal of several possible airports (taking into account a set of criteria) in the case of an action involving diverting to a nearby airport.

The metadata register 166-2 used by the notification generation unit 162 can include priority indicators that can be associated with the notifications according to predefined rules and as a function of the information concerning the suggestion. As used herein, a priority indicator refers to the display priority of the suggestion. The priority indicator can be defined, for example, as a function of information relating to the importance and/or the urgency of transmitting the suggestion to the crew. This importance and/or urgency information is associated with the suggestion (for example, in order to indicate “high” or “low” importance, or “high” or “low” urgency) by the event management device 140. The importance and/or urgency information also can be modified by the suggestion processing device 160 as a function of timestamps and/or of current or future mission data for each step of the method of the invention. The metadata called ‘priority metadata’ therefore changes with the priority of the suggestion. The priority metadata is taken into account during step 440 of applying a classification operation to the notification, and during step 450 of processing the notification, implemented by the notification classification and processing unit 164.

According to some embodiments, a priority metadata can be “moderate” or “high”. A notification, called ‘moderate priority notification’, refers to a low priority suggestion for the current mission, while a notification, called ‘high priority notification’, refers to a high priority suggestion to be sent to the crew, in connection with, for example, a possible critical status of a component in one of the certified systems of the avionics.

Advantageously, integrating a priority metadata in the method of the invention allows the level of importance and/or urgency of a suggestion to be easily identified, and consequently allows the workload of the crew to be reduced, with the operators being more attentive to the priority tasks integrated in their sets of actions.

On completion of step 440 of applying a classification operation to the notification stored in the notifications memory 166-4, a class denoted X is associated with the notification x. The class X(x) is determined from a set of classes (U, V and W, for example), and as a function of predefined rules implemented by the notification classification and processing unit 164. The first class corresponding to the class of notifications “to be executed” by the notification classification and processing unit 164 is denoted V. The second class corresponding to the class of notifications “to be archived” (in a backup memory 166-6) is denoted W. The third class U corresponds to the “standby” class of notifications.

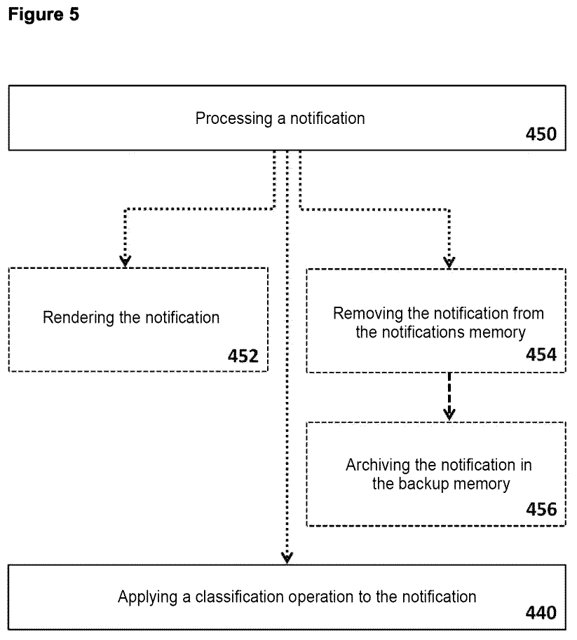

FIG. 5 is a diagram illustrating the various possible sub-steps of the step 450 of processing the notification as a function of the determined class X, by the notification classification and processing unit 164, according to embodiments.

The step 452 of rendering on the Human-Machine interface 180 is a sub-step of the notification processing. This sub-step 452 is implemented if a notification belonging to the class X meets a display condition defined such that X⊆V∨X⊆W (1). The formulation (1) indicates that the class X is either included in the first class V or included in the second class W.

In the sub-step 454, the notification can be deleted from the notifications memory 166-4, then saved in the backup memory 166-6 in the sub-step 456. These sub-steps 454 and 456 are implemented if the processed notification corresponds to a class X meeting the backup condition of X⊆W (2). The formulation (2) indicates that the class X is included in the second class W.

The step 440 of applying a classification operation implemented by the notification classification and processing unit 164 can be repeated, as a possible sub-step of step 450, if the processed notification corresponds to a class X meeting a reclassification condition of X⊆U∨X⊆V (3). The formulation (3) indicates that the class X is either included in the first class V or included in the third class U.

The method according to the embodiments of the invention thus allows efficient processing of the suggestions and optimized display of the associated notifications on the Human-Machine interface 180 (i.e. triggered at the most suitable times), taking into account the content of the suggestions and the monitoring of the current situation of the mission. The monitoring of the current situation of the mission refers to the updates, carried out at a frequency predefined by the device, of the current or future mission data sources 120, notably in order to keep:
monitoring the status of the aircraft and of the avionics (for example, and in a non-limiting manner, by monitoring the flight phase);
monitoring the environment (for example, by monitoring the weather); and/or
monitoring the actions of the crew operators of the aircraft (for example,
monitoring the interactions of the operators on various Human-Machine interfaces of the cockpit systems), or even by monitoring the physiological status of the crew operators of the aircraft (i.e. monitoring associated with audible, visual or even health sensors connected to the operators).

Thus, the notification generation unit 162 and the notification classification and processing unit 164 are adapted to take into account, in their respective predefined rules, at least some of the content of the suggestions, and at least some of the monitoring of the current situation of the mission. According to some embodiments, these units 162 and 164 can be at least partly connected to the current or future mission data sources 120 (for example, updating the context following a change in the flight phase).

In particular, the step 440 of applying a classification operation can take into account information relating:
to the suggestions;
to monitoring the current situation of the mission and notably to the ability of the crew operators to process the notification;
to the type of notification (for example, “simple” or “complex”) and to the priority indicator of the notification (relative to the present time, for example); and/or
to the various timestamps of the notification by the notification generation unit 162 and the notification classification and processing unit 164.

The data processing method described in FIG. 4 therefore comprises at least one iteration of the steps 440 of applying a classification operation, 450 of processing the notification, and 452 of rendering the notification.

In order to better understand the invention, the remainder of the description will be provided with reference to certain mechanisms of step 440 of applying the operation of classifying a notification, by way of non-limiting examples. A person skilled in the art will easily understand that these mechanisms can be generalized to any mechanism allowing the classification operation to be applied to all the notifications by the notification classification and processing unit 164.

The class U, referred to as “standby” class, can be associated with the notifications with suggestions that are to be placed on standby. Suggestions placed on standby correspond to the suggestions that must be communicated to the aircraft crew, but for which the optimal communication time (the most suitable and the most relevant time for such a communication) has not yet been reached (thus, the optimal time is a future time). Advantageously, such notifications are stored in the notifications memory 166-4 and processing for rendering on the Human-Machine interface 180 for these notifications is not applied. These notifications therefore remain invisible to the aircraft crew, which limits the computational load and the visual clutter of the Human-Machine interface 180. This results in a reduction in the mental load of the crew operators, with these notifications being intended to be processed at a later date.

For example, considering a mission with several legs, the notifications, associated with suggestions provided by the event management device 140 relating to a meteorological event affecting the next leg, can be classified as “standby” notifications. Thus, according to a predefined rule, these notifications will not be fed back to the crew, via the Human-Machine interface 180, in the event that the aircraft is in an approach phase situation. Indeed, this flight phase corresponds to a critical moment for piloting the aircraft. As a result, rendering such notifications during this phase would be unnecessary, or even dangerous, and would notably momentarily increase the mental load of the crew. However, this notification can be displayed at a later, more optimal time, for example when the aircraft will be on the ground in a situation involving the phase of preparing the next leg.

In another example, following a system failure of the avionics (for example, a hydraulic failure, or in the event of an engine fire on the aircraft), the first objective of the crew is to manage this system failure and return the airplane to a stable status. The first actions of the crew therefore relate to dealing with this failure. The notifications connected to the solutions involving reconfigurations of the mission connected to this failure must not be displayed as long as these first actions are not completed. By way of an example, the crew operators are initially required to perform one or more of the procedures (of varying length) connected to the warning raised by the certified FWS (Flight Warning System). Only then, when the failure is managed, can the crew operators consider a diversion to a nearby airport. Furthermore, the event management device 140 at the same time may have computed diversion solutions to be suggested to the crew. However, according to the invention, the notification associated, generated and processed by the suggestion processing device 160 will only be displayed when the crew operators will be most likely to take it into consideration, i.e. once the operators have completed the procedures for processing the failure.

The class V referred to as “to be executed” is thus associated with the notifications to be displayed in real time or in quasi-real time. The notification must be displayed.

The class W referred to as “to be archived” is associated with the notifications with suggestions that are considered to be processed. The notification must be archived in a backup memory (166-6) connected to said current or future mission data sources (120).

According to some embodiments, a notification corresponding to the “standby” class X⊆U or to the “to be executed” class X⊆V can be re-classified to the “to be archived” class W, in the event that the suggestion is no longer relevant in terms of monitoring the current situation.

In some embodiments, a notification corresponding to the “to be executed” class X⊆V can be re-classified to the “to be archived” class W following one or more actions of the crew indicating the rejection or the acceptance of the suggestion associated with the notification. For example, an operator can “Reject” or “Accept” the suggestion through the Human-Machine interface 180.

In the aforementioned example of the system failure of the avionics, following the warning raised by the FWS, the notification classification and processing unit 164 associates the “standby” class U with the notifications associated with the solutions of mission reconfigurations connected to this failure. When the failure processing procedures are completed, the information is integrated into the current or future mission data sources 120, which generates an operation of reclassifying the set of notifications related to this failure. The notification classification and processing unit 164 will associate, during this reclassification operation, the class V, referred to as “to be executed”, with notifications relating to solutions involving mission reconfigurations related to this failure.

In one embodiment, the step 440 of applying the operation of classifying a notification corresponding to the class X⊆V (“to be executed” class) can be implemented as a function of the timestamps associated with the notification. In particular, such a notification can be re-classified to the class W referred to as “to be archived”, as a function of a time that is predetermined and computed based on the timestamp metadata of the notification, such as the creation timestamp, the classification timestamps, the processing timestamps, and/or the action timestamps of the notification.

Considering, for example, a simple or complex notification of class X⊆V that is considered “to be executed” and a timestamp of this classification denoted T_{V(classification)}, the notification can be re-classified to the class W referred to as “to be archived” if the notification classification and processing unit 164, with an internal clock defining a time t, detects a specific duration defined by T₀=t−T_{V(classification)}, with T₀ denoting a value that is preset by rules for re-classifying simple or complex notifications. Advantageously, this allows a simple or complex notification to be automatically rejected by the suggestion processing device 160 after a certain time period, such as, for example, T₀=5 minutes.

According to another example, a complex notification of class X⊆V may not be re-classified to class W, referred to as “to be archived”, as long as an operator has not carried out a specific action, for example an action defined in an operational procedure included in the suggestion associated with the notification. In this example, implementing this specific action by the operator induces an action timestamp denoted T_{V(action)}. Thus, if the notification classification and processing unit 164 detects a specific duration defined by T₀=t−T_{V(action)}, with To denoting a value that is preset by rules for re-classifying complex notifications. Advantageously, this allows a complex notification to be automatically rejected by the suggestion processing device 160 after a certain time period, based on the time when an operator has carried out a specific action, such as, for example, T₀=5 minutes.

Thus, according to embodiments, repeating the classification operation can be triggered by controlling the duration as a function of the timestamp metadata, by modifying the data acquired during a mission, and/or by controlling an action detected on the Human-Machine interface 108.

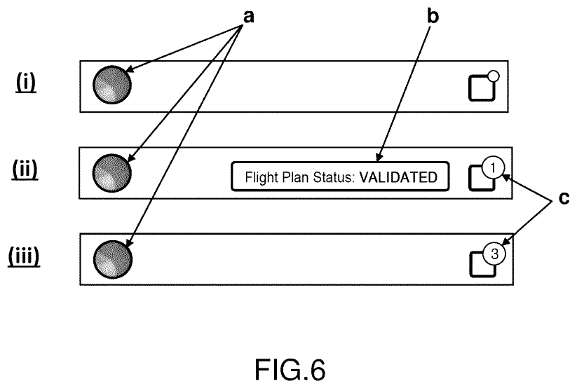

FIGS. 6, 7 and 8 show several renderings of notifications on the Human-Machine interface 180, by way of non-limiting examples. These examples of rendering include display forms, notably graphical and textual forms, on a screen of the Human-Machine interface 180. These display forms and the display dynamics associated with each notification make it easier for the operators of the aircraft to quickly understand the content of a notification and to make their decisions. These forms can be implemented according to a condensed graphical format (for example, with a strip display of the notification) or according to an extended graphical format (for example, with a display in a notification center). In an extended graphical format, these forms also can be implemented according to a short text format (for example, with the notification being displayed combined with a notification title) or according to a full text format (for example, displaying text intended to be read and/or heard by the operator).

FIG. 6 shows several examples of rendering notifications in a first display form, called ‘condensed form’, in a strip on the Human-Machine interface 180. As used herein, a strip refers to a rectangle at the top of a screen of the Human-Machine interface 108 containing a set of graphical or visual elements, as shown in FIG. 6 (i), (ii) and (iii).

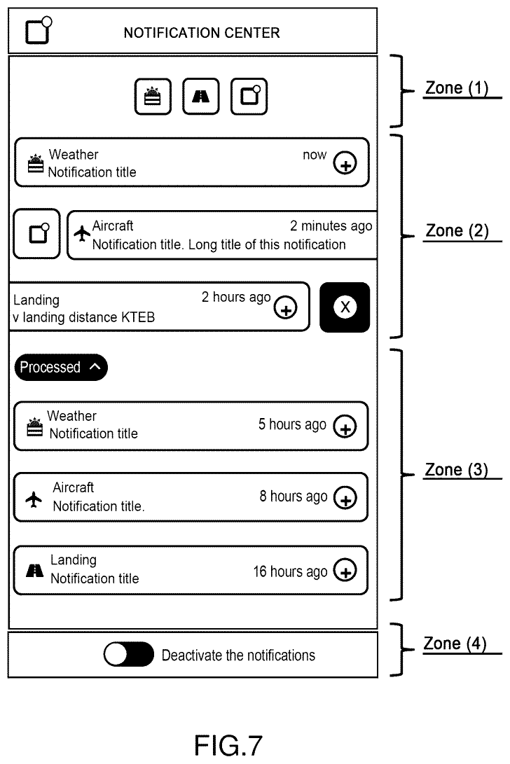

According to some embodiments, a first element contained in the strip is a means (for example, a clickable icon denoted (a) in FIG. 6) used for rendering notifications according to another display form, such as a display form shown in FIG. 7 and called ‘extended form’. For example, in a display in a condensed form, selecting the graphical element (a) can trigger the display of an extended form.

A second element contained in the strip can be a rectangle able to be displayed in the zone corresponding to the strip and containing an item of information (or action) related to the suggestion associated with the processed notification. This element (or ‘toast’) is shown in FIG. 6 (ii), and is denoted (b). The information is displayed in a short text format such as a title and can represent a summary of a suggestion. Similarly, the ‘toast’ can be used for rendering notifications according to the extended form. For example, when displaying a notification in a condensed form, selecting the graphical element (a) can trigger displaying the notification in an extended form.

An element contained in the strip, as an alternative embodiment, can correspond to a digit or a number linked to the list of notifications associated with the class V, referred to as the “to be executed” class, to be executed by the notification classification and processing unit 164. This element can be defined by a graphical label containing the digit or the number, as shown in FIG. 6 (ii) and (iii), and is denoted (c).

Other elements, not shown in the figures, can be contained in the strip, such as a search field allowing an operator of the aircraft to interact with part of the aircraft piloting assistance device 100, a logo created to identify the aircraft piloting assistance device 100, or even a means (clickable link, for example) allowing a crew operator to configure the Flight Policy.

In these examples, the condensed form is characterized by displaying a single notification at a time and in a short text format. This condensed form refers to a display on the Human-Machine interface 180. With the aircraft piloting assistance device 100 being connected to various cockpit systems (via various components on a computing platform of the certified avionics and of the non-certified avionics), this condensed form can also refer to another instantiation of these cockpit systems on Human-Machine interfaces. For example, this condensed form can be used on a PED (Personal Electronic Device), or on an EFB (Electronic Flight Bag) system. The EFB is an electronic system installed in the cockpit, for use by aircraft flight crew, with functionalities that replace those traditionally fulfilled by using paper documentation such as navigational charts, the operating manual, performance computations. The EFB can also have additional functionalities, not fulfilled by paper documentation, such as displaying the position of the aircraft on the navigational charts. In addition, this condensed form can be displayed on the Human-Machine interface of a workspace connected to a non-certified system.

According to some embodiments, for simple or complex notifications, the associated display dynamics involve an initial rendering of the notifications in said condensed form through the strip on the Human-Machine interface 180. In other words, if, after an iteration of step 440 involving applying an operation for classifying a simple or complex notification (previously unclassified or of class X⊆U), the class X of the notification meets the condition of X⊆V, then the rendering step 452 uses the condensed display form. Advantageously, such display dynamics correspond to minor interactions with the crew operators and hardly interferes with their activities.

According to some embodiments, for simple or complex notifications, the initial rendering of the notifications in condensed form can involve display dynamics determined as a function of a predetermined time and computed from the timestamp metadata of the notification, such as the creation timestamp, the classification timestamp, processing timestamps or even one of the action timestamps of the notification.

For example, a simple or “complex informative” notification is considered with a timestamp for processing an initial rendering of the notification in condensed form denoted T_{V(processing)}. The notification classification and processing unit 164, with an internal clock defining a time t, can then implement this rendering of the notifications on the strip of the Human-Machine interface 180 according to a specific display duration defined by T₀=t−T_{V(processing)}, with To denoting a value that is preset by predefined rules. Advantageously, this allows a simple or “complex informative” notification to be automatically displayed on the strip for a certain time period only, and to be removed from the strip at the end of this specific duration, such as, for example T₀=5 seconds.

In another example, a “complex recommendation” notification is considered with a timestamp for processing an initial rendering of the notification in condensed form denoted T_{V(processing)} and comprising an action (defined, for example, in an operational procedure included in the suggestion associated with the notification). The implementation of this specific action by the operator results in an action timestamp denoted T_{V(action)}. In this example, the notification classification and processing unit 164, with an internal clock defining a time t, renders the notifications on the strip of the Human-Machine interface 180 throughout the specific display duration defined by T₀=t−T_{V(action)}, with To denoting a value that is preset by predefined rules, independently of the timestamp T_{V(processing)}. Advantageously, this allows a complex notification to be automatically displayed on the strip until an operator has carried out a specific action, then for a certain time period after this action has been carried out with, for example, T₀=5 seconds. An example of a specific action can involve actuating the means given to the crew operator on the strip for rendering different notifications, such as, for example, in extended form.

According to some embodiments, for simple or complex notifications, rendering the notifications in condensed form can involve display dynamics associated with displaying the graphical label listing the notifications. In particular, the number or the digit contained in the graphical label can correspond to the count (or tally) and the incrementation of the number of notifications associated with the class V, referred to as the “to be executed” class, which have not undergone processing for rendering notifications in the extended form via a notification center. Thus, if the notification center is opened, for example, by actuating the means given to the crew operator on the strip for rendering notifications in the “extended form”, then by definition all the notifications appear in the notification center. As a result, the number or the digit contained in the graphical label is equal to zero. If this value is zero, according to some embodiments, this graphical label can be removed from the strip on the Human-Machine interface 180, as shown in FIG. 6 (i).

In another example, a simple notification is considered comprising elementary information to be transmitted to the crew, such as information for updating the status of the flight plan in the workspace connected to a non-certified system. The various update statuses of the flight plan can include a “draft” status, a “rejected” status, or a “validated” status, for example. Advantageously, an operator of the aircraft can import a flight plan into a certified avionics system, if the status of the flight plan in the workspace is “validated”. As a result, the aircraft piloting assistance device 100 transmits the useful information to the operator of the aircraft for updating the flight plan as a “validated” status. To this end, the simple notification can have display dynamics comprising an initial rendering of the notifications in the “condensed” form throughout the specific display duration defined by the timestamp metadata of the notification, for example a duration T₀=t−T_{V(processing)}=5 seconds. Notably, the associated elementary information is displayed on the toast of the strip on the Human-Machine interface 180, according to the following short text format, “Flight Plan Status: VALIDATED”, as shown in FIG. 6 (ii). In this case, the digit contained in the graphical label associated with the notification listing is incremented by 1.

FIG. 7 shows an example of rendering notifications in a display form referred to as ‘extended form’. Typically, the extended form in FIG. 7 is defined in accordance with the display of a notification center on the Human-Machine interface 108. As used herein, a notification center refers to an application page in a screen of the Human-Machine interface 180 made up of, for example, several zones containing various sets of elements, as shown in FIG. 7.

In embodiments, a zone forming the notification center can include a zone for filtering notifications per category. In this context, the category of the notification can be one of the metadata of the notification associated according to rules predefined for the suggestion by the notification generation unit 162, from among the categories of the environment (for example, weather, condition of the airport runways, etc.) or even the status of the aircraft. The elements contained in this prioritization zone therefore can be means (by a set of clickable icons, for example, as shown in zone (1) of FIG. 7) used for rendering notifications and allowing filtering or prioritization of the notifications as a function of these categories. Advantageously, the operator can thus select the category of notifications to be displayed in the notification center.

According to some embodiments, a zone making up the notification center can include the list of notifications associated with the class V, referred to as the “to be executed” class, to be executed by the notification classification and processing unit 164. The elements contained in this zone can be notifications in a form relating to the condensed form (then called “current notification boxes” and shown by way of an example in zone (2) of FIG. 7) and therefore involving displaying the one or more items of information (or the one or more actions) relating to one or more parameters associated with a mission determined from a suggestion. The order that the notifications appear in this list can be defined by the priority metadata, i.e. as a function of the priority for transmitting the suggestion to the crew. Finally, the current notification boxes may contain an item of time information (or duration) determined from the timestamp metadata of the notification, i.e. from the creation timestamp, the classification timestamps, the processing timestamps or even the action timestamps of the notification.

According to some embodiments, a zone making up the notification center can include the list of notifications associated with the class W, referred to as the “to be archived” class, to be archived by the notification classification and processing unit 164. The elements contained in this zone, referred to as the ‘archiving zone’, also can be notifications in a form similar to the condensed form (then called “archived notification boxes” and shown by way of an example in zone (3) of FIG. 7) and therefore involving displaying the one or more items of information (or the one or more actions) relating to one or more parameters associated with a mission determined from a suggestion. The archived notification boxes can contain an item of time information (or duration) determined from the timestamp metadata of the notification. An additional element, called ‘triggering element’, contained in the archiving zone can be a means (corresponding to a clickable icon, for example, as shown in zone (3) of FIG. 7) used for rendering notifications and allowing the list of notifications to be hidden by removing the display of these archived notification boxes. Thus, selecting this triggering element can trigger the display or the occlusion of the archiving zone. Advantageously, two implementation possibilities are possible, with the archiving zone being able:
to be hidden by default and to be displayed by the crew operator only when required; or
conversely, to be displayed by default.

Displaying the list of archived notification boxes can allow the suggestions applied by the crew to be distinguished from those that have not been applied. Displaying the list of archived notification boxes can also allow the non-applied suggestions to be distinguished since they are obsolete or not applied since they are explicitly rejected by a crew operator.

According to some embodiments, a zone making up the notification center can be a means (corresponding, for example, to a clickable icon, as shown in the zone (4) of FIG. 7) used to deactivate rendering of notifications. Advantageously, selecting this graphical element triggers the interruption of the rendering step (452) and therefore allows the notifications to be deactivated to be displayed.

According to some embodiments, for “complex informative” or “complex recommendation” notifications, the associated display dynamics can involve initial rendering of the notifications in the “extended form” by displaying the notification center on the Human-Machine interface 108. In other words, if, after an iteration of step 440 involving applying an operation for classifying a complex notification (previously unclassified or of class X⊆U), the class X of the notification meets the condition of X⊆V, then the rendering step 452 uses the extended display form. Such display dynamics correspond to an interaction prevalent with the crew operators. It is included in an urgency and/or high importance situation, involving recommending the suggestion associated with the notification being taken into account at this time.

According to some embodiments, rendering the notifications in “extended form”, by displaying the notification center on the Human-Machine interface 108, for the “complex informative” or “complex recommendation” notifications, can take into account the priority metadata, i.e. the metadata reflecting the priority for transmitting the suggestion to the crew. By way of an example, a high priority notification can include visually enhanced display characteristics for more quickly attracting the attention of an operator, such as an associated bright color display (for example, amber) and/or a larger or bold text font. Conversely, a moderate priority notification will include the nominal display characteristics for rendering notifications.

The notification rendering step 452 can thus take into account the type of the notification, i.e. the various forms and the display dynamics. In an extended graphical format, these forms also can be implemented in a short text format (for example, with the notification being displayed with a notification title made up of a few words) or in a full text format (for example, displaying a text). The notification boxes (in progress or archived) described with reference to FIG. 7 represent an embodiment of a notification displayed in a short extended form.

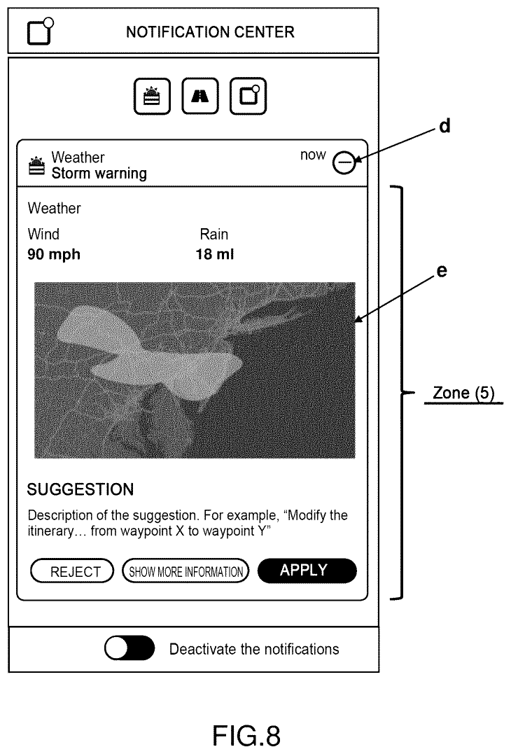

In order for the operators of the aircraft to better understand a notification, an additional element (denoted (d) in FIG. 8) can be included in the complex notification boxes, for example. As shown in FIG. 8, this element (d) can be a means (corresponding, for example, to a clickable icon) used to generate an alternative rendering of the notification in extended form in the notification center on the Human-Machine interface 180. The associated notification box is then shown in dropdown form, which in this example allows a short text format to be displayed (or title of the notification, which in the example of FIG. 8 is “Storm warning”), with a full text format including, for example, additional information, digital data and optionally graphical elements such as the image (e) of FIG. 8.

This extended form, referred to as “full” form, allows a crew operator to be provided with additional information in the event that the extended form, referred to as “short” form, of the notification determined by the notification generation unit 162 is not sufficient for clearly reproducing the content of the suggestion computed by the event management device 140.

For notifications of the “complex recommendation” type, the associated notification box, shown in dropdown form, can also contain a means (a touch-sensitive button indicating “Show more information”, for example) used for generating another alternative rendering of the notification on the Human-Machine interface 180. For example, considering the example of a current mission involving the diversion of an aircraft, an operator of the aircraft may prefer to view a notification on another application page (not shown in the figures) of the Human-Machine interface 180, in order to be able to display various items of information and/or choices of actions included in the associated suggestion. Advantageously, this allows a comparative visualization and a display of the criteria used for the computations of the suggestions to be provided, as well as visual classification in terms of the relevance of a suggestion or even allows the details of some specific choices of the suggestion to be displayed at the request of the operator.

According to some embodiments, for “complex recommendation” notifications, the associated display dynamics can include an initial rendering of the notifications in the form referred to as “full extended” form by displaying the dropdown notification in the notification center on the Human-Machine interface 108. Advantageously, this corresponds to significant interaction with the crew operators in a “high” urgency and “high” importance situation, implying recommending that the suggestion associated with the notification is taken into account immediately. In this case, the associated display dynamics include a subsequent rendering of these notifications in the “short” form as a function of a time that is predetermined and computed based on the timestamp metadata of the notification. The subsequent rendering in the “short” form also can be implemented following an action of a crew operator via the means (by a clickable icon, for example) provided to generate the alternative rendering of the notification.

In these non-limiting examples, the various forms referred to as extended, short or full forms are characterized by displaying multiple notifications in the notification center referring to the Human-Machine interface 108. However, with the aircraft piloting assistance device 100 being connected to various cockpit systems (via various components on a computing platform of the certified avionics and of the non-certified avionics), extended forms can also refer to other instantiations on Human-Machine interfaces of these cockpit systems. For example, a full extended form can be displayed on the Human-Machine interface of a workspace connected to a non-certified system. Advantageously, this allows the crew operators to make more conscious, qualified choices with respect to the suggestions computed by the event management device 140 in a common workspace.

Considering the example of a current mission involving the diversion of an aircraft, an operator of the aircraft may prefer to view the notification on a specific page of the workspace of a non-certified system, in order to be able to superimpose the summary of the situation delivered by the workspace and the various suggestions computed by the event management device 140. Advantageously, this allows a comparative visualization, for example on a chart, and a display of the criteria used for the computations of the suggestions to be provided, as well as visual classification in terms of the relevance of a suggestion or even allows the details of some specific suggestions to be displayed at the request of the operator. Thus, according to some embodiments, for notifications of the “complex recommendation” type, the associated display dynamics can also include rendering the notifications on the Human-Machine interface of a workspace connected to a non-certified system via the means using a touch-sensitive button indicating “Show more information”, for example.

A person skilled in the art will understand that the notification processing device or sub-systems of the device according to the embodiments of the invention can be implemented in various ways by hardware, software, or a combination of hardware and software, notably in the form of program code that can be distributed in the form of a program product, in various forms. In particular, the program code can be distributed using computer-readable media, which can include computer-readable storage media and communication media. The methods described in the present description notably can be implemented in the form of computer program instructions that can be executed by one or more processors in a computer device. These computer program instructions also can be stored in a computer-readable medium.

Moreover, the invention is not limited to the embodiments described above by way of a non-limiting example. It encompasses all the alternative embodiments that can be contemplated by a person skilled in the art. In particular, the invention is not limited to the examples provided in the description by way of a non-limiting example.

1. A method for processing data generated by an event management device of an aircraft piloting assistance device, said device determining mission adaptation suggestions from current or future mission data sources, the method comprising the following steps of:
receiving, from the event management device, at least one suggestion, said suggestion comprising at least one item of information and at least one datum related to the construction of said suggestion;
generating at least one notification for each received suggestion as a function of at least one of said items of information, said notification comprising said suggestion and at least one metadata structured from a metadata register, the notification comprising timestamp metadata, said timestamps comprising a generation timestamp for said notification, at least one classification timestamp for said notification, at least one processing timestamp for said notification and/or at least one action timestamp related to the execution of an action;
storing said at least one notification in a notifications memory;
the method further comprising at least one iteration of the following steps:
applying a classification operation to a notification stored in the notifications memory, said classification operation associating a class X with the notification, said class being determined as a function of predefined rules from a set of classes comprising at least a first class V and a second class W, said predefined rules depending on a set comprising weighting criteria, criteria defined by an ontology and/or criteria defined by rules;
applying processing to said notification as a function of the determined class X, said processing comprising a step of rendering the notification on a Human-Machine interface if the class X meets a display condition depending on whether the class X belongs to the first class V or to the second class W, said rendering using at least one display form and display dynamics defined as a function of the metadata associated with the notification.

2. The data processing method as claimed in claim 1, wherein the current or future mission data sources comprise the data acquired from various systems of the certified avionics or of the non-certified avionics and/or from various outside sources or sources inside the aircraft, the method further comprising a step of transferring data to said systems of the certified avionics and/or of the non-certified avionics.

3. The data processing method as claimed in claim 2, wherein the data transfer step comprises a step of rendering said notification on at least one other Human-Machine interface connected to said certified avionics and/or non-certified avionics.

4. The data processing method as claimed in claim 1, wherein the first class V identifies a “to be executed” notification indicating that the notification must be executed, and the second class W identifies a “to be archived” notification indicating that the notification must be archived in a backup memory connected to said current or future mission data sources.

5. The data processing method as claimed in claim 4, wherein said classes further comprise a third class U identifying a “standby” notification indicating that the notification must be placed on standby.

6. The data processing method as claimed in claim 4, wherein the class X meets the reclassification condition X⊆U∨X⊆V, the processing step comprising reiterating the step of applying a classification operation.

7. The data processing method as claimed in claim 6, wherein the step of reiterating the classification operation is triggered as a function of:
controlling a duration determined from the timestamp metadata;
modifying the data acquired during a mission; and/or
controlling an action detected on the Human-Machine interface.

8. The data processing method as claimed in claim 4, wherein the class X meets the backup condition of X⊆W, with the processing step comprising a step of deleting said notification from the notifications memory and a step of archiving said notification in said backup memory.

9. The data processing method as claimed in claim 1, wherein the metadata register further comprises:
simple metadata associated with the notifications comprising an item of information or an action relating to at least one mission parameter, said information or action being determined from said suggestion; and
complex metadata associated with the notifications comprising a concatenation of several items of information or actions relating to at least one mission parameter, said information or actions being determined from said suggestion.

10. The data processing method as claimed in claim 1, wherein the metadata register further comprises a priority metadata associated with the notifications, said priority metadata being determined from said suggestion and updated at each step of the method, said priority metadata being associated with the importance and/or the urgency of the information or actions relating to at least one mission parameter, said priority metadata comprising at least two priority indicators, including a high priority indicator and a moderate priority indicator.

11. The data processing method as claimed in claim 1, wherein the metadata register comprises metadata defining the category of the information and/or actions relating to said suggestion from among environmental categories, and the status of the aircraft.

12. The data processing method as claimed in claim 1, wherein said display form defined as a function of the metadata associated with a notification comprises a first display form and a second display form, with the rendering step using the first display form to generate the display of at least:
a first graphical element, with the selection of said graphical element triggering the second display form;
a second graphical element containing an item of information or an action relating to at least one mission parameter, with said information or action being determined from said suggestion, with the selection of said graphical element triggering the display of said information or action in a first zone of the second display form.

13. The data processing method as claimed in claim 12, wherein the rendering step comprises:
counting notifications from the number of non-rendered notifications using the second display form;
incrementing the number of non-rendered notifications using the second display form; the rendering step using the first form to also generate the display of the number of counted notifications not displayed in the second display mode.

14. The data processing method as claimed in claim 11, wherein the rendering step uses the second display form to generate the display of at least:
the first zone comprising a first set of at least one graphical element, generated from a suggestion of a notification whose class X meets the condition of X⊆V, the graphical elements of the first set comprising displaying at least one item of information or an action relating to at least one mission parameter, said item of information or action being determined from said suggestion, said graphical elements further comprising displaying at least one duration defined by the timestamp metadata of said suggestion;
a second zone comprising a second set of at least one graphical element, the selection of said graphical elements of the second set triggering filtering of the rendering of the notifications according to filtering criteria;
a third zone comprising a third set of at least one graphical element, generated from a suggestion of a notification whose class X meets the condition of X⊆W, the third set comprising a triggering graphical element, with the selection of said triggering graphical element triggering the display or the occlusion of the third zone;
a fourth zone comprising a fourth set of at least one graphical element, with the selection of said graphical element triggering the interruption of the rendering step (452).

15. The data processing method as claimed in claim 9, wherein if, after an iteration of the step of applying a classification operation for a notification of class X⊆U, the class X of the notification meets the condition of X⊆V, with said notification being associated with a type of metadata, then the rendering step uses the first display form for a duration defined by the timestamp metadata of said notification.

16. The data processing method as claimed in claim 9, wherein if, after an iteration of the step of applying a classification operation for a notification of class X⊆U, the class X of the notification meets the condition of X⊆ V, with said notification being associated with a complex metadata, then the rendering step uses the second display form.

17. A computer program product comprising instructions for executing the method as claimed in claim 1 when the program is executed by a processor.

18. A device for processing mission adaptation suggestions generated from current or future mission data sources, said suggestions being generated by an event management device, the device being configured for:
receiving, from the event management device, at least one suggestion, said suggestion comprising at least one item of information and at least one datum related to the construction of said suggestion;
generating at least one notification for each received suggestion as a function of at least one of said items of information, said notification comprising said suggestion and at least one metadata structured from a metadata register, the notification comprising timestamp metadata, said timestamps comprising a generation timestamp for said notification, at least one classification timestamp for said notification, at least one processing timestamp for said notification and/or at least one action timestamp related to the execution of an action;
storing said at least one notification in a notifications memory;
the device further being configured to implement at least one iteration of the following operations:
applying a classification operation to a notification stored in the notifications memory, said classification operation associating a class X with the notification, said class being determined as a function of predefined rules from a set of classes comprising at least a first class V and a second class W, said predefined rules depending on a set comprising weighting criteria, criteria defined by an ontology and/or criteria defined by rules;
applying processing to said notification as a function of the determined class X, said processing comprising a step of rendering the notification on a Human-Machine interface if the class X meets a display condition depending on whether the class X belongs to the first class V or to the second class W, said rendering using at least one display form and display dynamics defined as a function of the metadata associated with the notification.
